(19) United States
(12) Patent Application Publication
(10) Pub. No.: US 2025/0356412 A1
(43) Pub. Date: Nov. 20, 2025

(54) ITEM INFORMATION PROVISION DEVICE, ITEM INFORMATION PROVISION METHOD, AND ITEM INFORMATION PROVISION PROGRAM

(71) Applicant: Rakuten Group, Inc., Tokyo (JP)

(72) Inventor: Maki KANEKO, Tokyo (JP)

(73) Assignee: Rakuten Group, Inc., Tokyo (JP)

(21) Appl. No.: 19/196,849

(22) Filed: May 2, 2025

(30) Foreign Application Priority Data
May 14, 2024 (JP) 2024-078552

(51) Int. Cl. G06Q 30/0601

(52) U.S. Cl. CPC G06Q 30/0643; G06Q 30/0625

(57) ABSTRACT

A device acquires a ratio of items in a predetermined category in found items. The device transmits page information for displaying pieces of information on items among the found items to a terminal device. Each of the pieces of information includes an image. The page information for displaying the pieces of information in a first display mode is transmitted when the ratio is lower than a predetermined ratio. The page information for displaying the pieces of information in a second display mode is transmitted when the ratio is equal to or higher than the predetermined ratio. Each of the pieces of information is displayed in a display area in the page. Each of the display modes includes an occupancy rate of the image to the display area. The occupancy rate in the second display mode is higher than the occupancy rate in the first display mode.

### CROSS REFERENCE TO RELATED APPLICATION

This application claims priority from Japanese Patent Application No. 2024-078552 which was filed on May 14, 2024, the disclosure of which is herein incorporated by reference in its entirety.

### BACKGROUND

### Technical Field

The present invention relates to a method for displaying pieces of information on items that have been found.

### Related Art

In the related art, there is known a technique of searching for items on the basis of a search condition designated by a user and providing a page including pieces of information of respective items that have been found to a terminal device of the user. In addition, it is also known that there are several display formats of pieces of information on items in this page. Examples of the display format include a list format and a grid format. The list format is a format in which pieces of information on items are displayed in one column and a plurality of rows. The grid format is a format in which pieces of information on items are displayed in a plurality of columns and a plurality of rows. In general, the list format tends to display more information of items as compared with the grid format. Further, in a case where information of an item includes an image, a ratio of the image to the entire information of the item tends to be higher in the grid format than in the list format.

In relation to the display format of pieces of information of items, JP 2023-121108 A discloses that an intention of a search query is determined on the basis of whether or not lowest layer categories can be narrowed down by a search query of a transaction target from a terminal device and the number of lowest layer categories that are identified by narrowing down and that a perspective and a display format of ranking information of the transaction target to be provided to a user are determined on the basis of the intention of the search query.

### SUMMARY

However, in a case where pieces of information on items are displayed in the same manner regardless of the items, the visibility of the pieces of information for the user may differ depending on the categories of the items. In the technique in the related art, a display mode of pieces of information on items is not switched depending on categories of the items that are actually found.

The present invention has been made in view of the above points, and an example of an object of the present invention is to provide an item information provision device, an item information provision method, and an item information provision program capable of displaying pieces of information on items in a mode corresponding to the items that have been found.

An aspect of the application is an item information provision device comprising: at least one memory configured to store program code; and at least one processor configured to access the program code and operate as instructed by the program code, the program code comprising: an acquisition code configured to cause the at least one processor to acquire a ratio of items in a predetermined category included in a plurality of items that have been found in response to a search request from a terminal device; and a transmission code configured to cause the at least one processor to transmit page information to the terminal device, the page information being for causing the terminal device to display a page including two or more pieces of information on two or more respective items among the plurality of found items, each of the two or more pieces of information on the two or more including image, respective items an wherein the transmission code is configured to cause the at least one processor to transmit the page information for displaying the two or more pieces of information on the two or more respective items in a predetermined first display mode in a case where the acquired ratio is lower than a predetermined ratio and transmit the page information for displaying the two or more pieces of information on the two or more respective items in a predetermined second display mode in a case where the acquired ratio is equal to or higher than the predetermined ratio, each of the two or more pieces of information on the two or more respective items is displayed in a respective display area in the page, each of the first display mode and the second display mode of the two or more pieces of information on the two or more respective items includes an occupancy rate of the image to the display area, and the occupancy rate in the second display mode is higher than the occupancy rate in the first display mode.

Another aspect of the application is an item information provision method performed by at least one computer, the method comprising: acquiring a ratio of items in a predetermined category included in a plurality of items that have been found in response to a search request from a terminal device; and transmitting page information to the terminal device, the page information being for causing the terminal device to display a page including two or more pieces of information on two or more respective items among the plurality of found items, each of the two or more pieces of information on the two or more respective items including an image, wherein the page information for displaying the two or more pieces of information on the two or more respective items in a predetermined first display mode is transmitted in a case where the acquired ratio is lower than a predetermined ratio and the page information for displaying the two or more pieces of information on the two or more respective items in a predetermined second display mode is transmitted in a case where the acquired ratio is equal to or higher than the predetermined ratio, each of the two or more pieces of information on the two or more respective items is displayed in a respective display area in the page, each of the first display mode and the second display mode of the two or more pieces of information on the two or more respective items includes an occupancy rate of the image to the display area, and the occupancy rate in the second display mode is higher than the occupancy rate in the first display mode.

Yet another aspect of the application is a non-transitory computer readable medium having stored thereon an item information provision program configured to cause a computer to: acquire a ratio of items in a predetermined category included in a plurality of items that have been found in response to a search request from a terminal device; and transmit page information to the terminal device, the page information being for causing the terminal device to display a page including two or more pieces of information on two or more respective items the plurality of found items, each of the two or more pieces of information on the two or more respective items including an image, wherein the page information for displaying the two or more pieces of information on the two or more respective items in a predetermined first display mode is transmitted in a case where the acquired ratio is lower than a predetermined ratio and the page information for displaying the two or more pieces of information on the two or more respective items in a predetermined second display mode is transmitted in a case where the acquired ratio is equal to or higher than the predetermined ratio, each of the first display mode and the second display mode of the two or more pieces of information on the two or more respective items includes an occupancy rate of the image to the display area, and each of the first display mode and the second display mode includes an occupancy rate of the image to the display area, and the occupancy rate in the second display mode is higher than the occupancy rate in the first display mode.

### BRIEF DESCRIPTION OF DRAWINGS

FIG. 1 is a diagram illustrating an example of a schematic configuration of a communication system according to an embodiment;

FIG. 2 is a block diagram illustrating an example of a schematic configuration of a shopping server according to the embodiment;

FIG. 3 is a diagram illustrating an example of information stored in a database of the shopping server;

FIG. 4 is a diagram illustrating an example of functional blocks of a system controller in the shopping server according to the embodiment;

FIG. 5A and FIG. 5B are diagrams illustrating an example of determining a display mode of information on an item;

FIG. 6 is a diagram illustrating an example of a search result page in a case where a ratio of fashion items among items s that have been found is lower than a threshold ratio;

FIG. 7 is a diagram illustrating a first example of a search result page in a case where a ratio of fashion items among items that have been found is equal to or higher than a threshold ratio;

FIG. 8 is a diagram illustrating a second example of a search result page in a case where a ratio of fashion items among items that have been found is equal to or higher than a threshold ratio;

FIG. 9 is a diagram illustrating a comparative example of occupancy rates of item images;

FIG. 10 is a diagram illustrating an example of a search result page in a case where a ratio of fashion items among items that have been found is equal to or higher than a threshold ratio after a display format is changed to a list format;

FIG. 11 is a diagram illustrating an example of a search result page in a case where a ratio of fashion items among items that have been found is lower than a threshold ratio after a display format is changed to a grid format;

FIG. 12A is a diagram illustrating an example of a correspondence relationship between a search result page and a display format in a case where a ratio of fashion items is lower than a threshold ratio; FIG. 12B is a diagram illustrating an example of a correspondence relationship between a search result page and a display format in a case where a ratio of fashion items is equal to or higher than a threshold ratio;

FIG. 13 is a flowchart illustrating an example of search processing executed by a system controller of the shopping server according to the embodiment;

FIG. 14 is a flowchart illustrating an example of processing that is for calculating a ratio of fashion items and is executed by a system controller of the shopping server according to the embodiment;

FIG. 15 is a flowchart illustrating an example of search result page generation processing executed by a system controller of the shopping server according to the embodiment;

FIG. 16 is a flowchart illustrating an example of processing that is for transmitting another search result page and is executed by a system controller of the shopping server according to the embodiment;

FIG. 17 is a flowchart illustrating an example of display format change processing executed by a system controller of the shopping server according to the embodiment;

FIG. 18A to FIG. 18C are diagrams illustrating an example of determining a display format;

FIG. 19 is a flowchart illustrating an example of processing that is for calculating a ratio of fashion items and is executed by a system controller of the shopping server according to the embodiment;

FIG. 20 is a flowchart illustrating an example of processing that is for transmitting another search result page and is executed by a system controller of the shopping server according to the embodiment;

FIG. 21A to FIG. 21C are diagrams illustrating an example of determining a display format; and

FIG. 22 is a flowchart illustrating an example of processing that is for calculating a ratio of fashion items and is executed by a system controller of the shopping server according to the embodiment.

### DETAILED DESCRIPTION

### 1. First Embodiment

Hereinafter, embodiments of the present invention will be described in detail with reference to the drawings. In the embodiments to be described below, the present invention is applied to an online shopping mall where a plurality of business operators sell items. On the other hand, the present invention may be applied to an online shopping site where only a single business operator sells items.

### 1-1. Configuration of Communication System

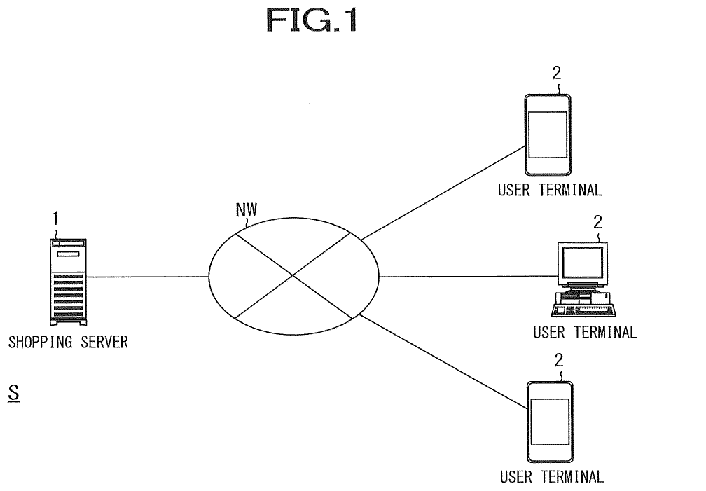

First, an outline of a configuration and a function of communication system S according to the present a embodiment will be described with reference to FIG. 1. FIG. 1 is a diagram illustrating an example of a schematic configuration of a communication system S according to the present embodiment.

As illustrated in FIG. 1, the communication system S includes a shopping server 1 and a plurality of user terminals 2. The shopping server 1 and the user terminals 2 are connected to each other via a network NW. The network NW is constructed by, for example, the Internet, a dedicated communication line (for example, a community antenna television (CATV) line), a mobile communication network (including a base station and the like), a gateway, and the like.

The shopping server 1 may be a server device that manages a predetermined online shopping mall. The online shopping mall may be a website on which a plurality of stores sell items. The shopping server 1 may transmit various types of web pages included in the online shopping mall to the user terminal 2. One such web page is a search result page. The search result page may be a web page including, as a search result of the items, two or more pieces of information on two or more respective items among the items that have been found. The information on each item that is displayed on the search result page may include an item image. The item image may be an image related to the item. Examples of the item image include an image of the item itself and any image related to the item. The shopping server 1 may search for items that satisfy a search condition which is input by the user. Examples of the search condition include a keyword, a category of an item, an attribute of an item, and the like.

Each user terminal 2 is a terminal device used by a user who uses an online shopping mall as a buyer of an item. Examples of the user terminal 2 include a portable information terminal such as a smartphone or a tablet computer, a mobile phone, a personal digital assistant (PDA), a personal computer, a set top box, and the like. The user terminal 2 transmits a request to the shopping server 1 on the basis of an operation of the user, and displays a web page transmitted from the shopping server 1 in response to the request. A web browser may be installed in each user terminal 2. In a case where the user terminal 2 is a portable terminal device, an application program dedicated to the online shopping mall may be installed in the user terminal 2. In this case, the user terminal 2 may display the web page of the online shopping mall according to the application program.

### 1-2. Configuration of Shopping Server

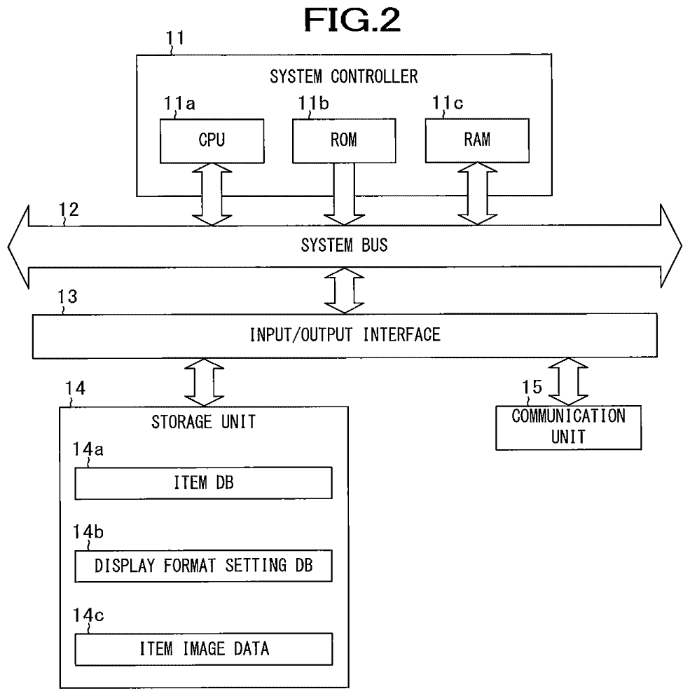

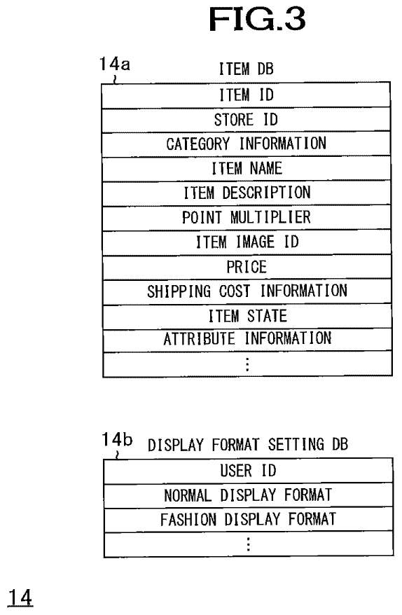

Next, a configuration of the shopping server 1 will be described with reference to FIGS. 2 and 3. FIG. 2 is a block diagram illustrating an example of a schematic configuration of the shopping server 1 according to the present embodiment. As illustrated in FIG. 2, the shopping server 1 includes a system controller 11, a system bus 12, an input/output interface 13, a storage unit 14, and a communication unit 15. The system controller 11 and the input/output interface 13 are connected to each other via the system bus 12.

The system controller 11 includes a central processing unit (CPU) 11a, a read only memory (ROM) 11b, a random access memory (RAM) 11c, and the like.

The input/output interface 13 performs interface processing between the storage unit 14 and the system controller 11 and between the communication unit 15 and the system controller 11.

The storage unit 14 includes, for example, a hard disk drive or the like. The storage unit 14 may store databases such as an item DB 14a and a display format setting DB 14b. “DB” is an abbreviation for a database. FIG. 3 is a diagram illustrating an example of information stored in a database of the shopping server 1.

The item DB 14a may store item information on each item that is sold by each store in the online shopping mall. For example, as illustrated in FIG. 3, the item DB 14a may store, as the item information, an item ID, a store ID, category information, an item name, an item description, an item image ID, point multiplier, a price, shipping cost information, an item state, attribute information, and the like in association with each other. The item ID may be identification information that is assigned to an item by a store to identify the item. The store ID may be identification information for identifying a store that sells items. Any item that is sold by any store in the online shopping mall may be identified with a combination of the item ID and the store ID. Alternatively, any item that is sold by any store may be identified only with the item ID. The category information may be information indicating a category of the item. Examples of the category include “sports/golf”, “fashion/underwear”, “fashion accessories”, “kids/baby/toys”, “home electric appliances/TV/cameras”, “PC/smart phones/communication”, “food/sweets”, and the like. The item name indicates a name of the item. The item description is a sentence indicating a description of the item. A point multiplier indicates what percentage of a price of the item will be given to a purchaser of the item as points. This point is managed in a predetermined loyalty program. The user can use the given point for purchase of an item or a service. For example, one point may correspond to one yen. The item image ID is identification information for identifying an item image related to the item. Examples of the item image ID include a URL, a file name, and a path name of the item image. A plurality of item image IDs may be stored for one item. The shipping cost information may be information indicating a shipping cost of the item for each region. The item state may indicate whether the item is a new item or a used item. In a case where the item is a used item, the item state may further indicate a quality of the state of the item. The attribute information indicates an attribute of the item. The attribute indicated by the attribute information is defined by the category to which the item belongs.

The display format setting DB 14b may store a display format that is set for each user as a display format of the search result page. The display format of the search result page may include a method of arranging pieces of information of the search results of the items on the search result page. For example, as illustrated in FIG. 3, the display format setting DB 14b may store a user ID, a normal display format, a fashion display format, and the like in association with each other. The user ID may be identification information for identifying the user. The normal display format may indicate a display format to be normally applied to the user. As the normal display format, either a list format or a grid format may be set. The list format may be a format in which the search results of the items are displayed in a list form. That is, the search results of the items are displayed in one column and a plurality of rows. The list format is also referred to as a list view. The grid format may be a format in which the search results of the items are displayed in a grid form. That is, the search results of the items are displayed in a plurality of columns and a plurality of rows. The grid format is also referred to as a grid view. A default of the normal display format is a list format. The default display format may be a display format to be applied to the user in a state where the user has not changed or set the display format so far. The fashion display format is a display format to be applied to the user, and may indicate a display format for a fashion item. The fashion display format may be set to either a list format or a grid format. A default of the fashion display format is a grid format. The normal display format and the fashion display format may be stored for each type of the user terminal 2. That is, the display format may be managed for each type of the user terminal 2 that displays the search results of the items. The type of the user terminal 2 possessed by the user may vary depending on the user. In addition, one user may possess a plurality of types of user terminals 2. For example, a normal display format and a fashion display format for a personal computer, and a normal display format and a fashion display format for a portable information terminal may be stored. The portable information terminal may include, for example, a smartphone and a tablet computer. A combination of the default of the normal display format and the default of the fashion display format may be different depending on the type of the user terminal 2. For example, both the default of the normal display format and the default of the fashion display format for a certain type of the user terminal 2 may be a grid format. In addition, both the default of the normal display format and the default of the fashion display format for a certain type of the user terminal 2 may be a list format.

The storage unit 14 may further store item image data 14c of each item. The item image data 14c is data of the item image. Examples of the format of the item image data include JPEG, TIFF, PNG, GIF, and the like. The item image data 14c may be associated with an item image ID or a URL of the item image data 14c. Further, the storage unit 14 may store a template of a hypertext markup language (HTML) document of the search result page and a style sheet of the search result page for each display format.

Furthermore, the storage unit 14 may store various programs such as an operating system, a database management system (DBMS), and a server program. The server program is a program that causes the system controller 11 to execute processing related to the online shopping mall. The server program may be acquired from, for example, another device via the network NW, or may be recorded on a recording medium such as a magnetic tape, an optical disc, or a memory card and read via a drive device.

The communication unit 15 includes, for example, a network interface card or the like. The communication unit 15 is connected to the user terminal 2 via the network NW and controls a communication state with the connected device.

### 1-3. Functional Outline of System Controller

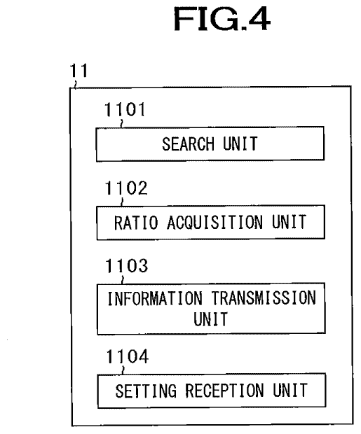

Next, a functional outline of the system controller 11 in the shopping server 1 will be described with reference to FIGS. 4 to 12B. FIG. 4 is a diagram illustrating an example of functional blocks of the system controller 11 in the shopping server 1 according to the present embodiment. The system controller 11 may function as a search unit 1101, a ratio acquisition unit 1102, an information transmission unit 1103, a setting reception unit 1104, and the like as illustrated in FIG. 4 by causing the CPU 11a to read and execute various program codes included in the server program.

The search unit 1101 may search for items in response to a request from the user terminal 2. For example, the user may be able to input a search condition on a front page and a search result page of the online shopping mall. The front page may be a web page corresponding to an entrance of the online shopping mall. The user terminal 2 may transmit a search request to the shopping server 1 in response to an input of a search condition by the user. The search request may include, for example, an input search condition and a user ID of the user. The search unit 1101 may search for items that satisfy the search condition included in the search request on the basis of the item DB 14a and other databases related to items.

The search unit 1101 may assign a display rank to each of the plurality of items that have been found. The display rank may correspond to, for example, a priority degree of display of the information of the item as a search result. For example, as the display rank is higher, the information of the item may be displayed at a higher position on the search result page. In addition, information of a plurality of items that have been found may be displayed across two or more search result pages in a divided way. For example, there is a case where an upper limit has been set for the number of items on which information can be displayed per search result page. This upper limit is referred to as the maximum number of displayable items. A page number may be assigned to each search result page. As the display rank is higher, the information of the item may be displayed on the search result page with a higher page number. Examples of the information for determining the display rank include a score determined by a predetermined algorithm or a predetermined calculation expression, a total of a price and a shipping cost, a price, a registration date of the item, the number of reviews on the item, an evaluation value of the item, and the like.

The ratio acquisition unit 1102 may acquire a ratio of items in a predetermined category included in the plurality of items that have been found by the search unit 1101. This category may be predetermined by, for example, an operator of the online shopping mall. As a factor that may have an influence on the selection of the item by the user, there are appearance of the item and information other than the appearance of the item. The appearance of the item is mainly recognized from the item image. For example, a category in which the appearance of the item has a larger influence on the selection of the item than other categories may be defined as the predetermined category. Examples of the category of such an item include fashion. The acquisition of the ratio of the items in the predetermined category may include calculating the ratio. In addition, the acquisition of the ratio of the items in the predetermined category may include acquiring the ratio calculated by the ratio acquisition unit 1102 or something. The ratio acquisition unit 1102 may determine whether or not each found item belongs to the predetermined category on the basis of the category information included in the item information of the item. For example, the ratio acquisition unit 1102 may determine that an item of which the category information is “fashion/underwear” is a fashion item. Alternatively, the ratio acquisition unit 1102 may determine that an item of which the category information is either “fashion/underwear” or “fashion accessories” is a fashion item. The ratio acquisition unit 1102 may calculate or count the number of items in the predetermined category. Further, the ratio acquisition unit 1102 may calculate or count the number of search results. The number of search results may indicate the total number of the items that have been found. The ratio acquisition unit 1102 may calculate the ratio of items in the predetermined category by dividing the number of items in the predetermined category by the number of search results. Note that the ratio acquisition unit 1102 may calculate a ratio of items in the predetermined category among items that satisfy a predetermined condition among all the items that have been found.

The information transmission unit 1103 may transmit, to the user terminal 2 that has transmitted the search request, page information that causes the user terminal 2 to display the search result page including two or more pieces of information on two or more respective items included in the plurality of items that have been found by the search unit 1101. The transmitted page information may include, for example, at least an HTML document between an HTML document and a style sheet. The information transmission unit 1103 may generate page information on the basis of information of each item stored in the item DB 14a. For example, the information transmission unit 1103 may include the URL of the item image of the item, in the page information, on the basis of the item image ID. Thereby, the user terminal 2 that displays the search result page transmits the URL of the item image to the shopping server 1. The information transmission unit 1103 transmits the item image data 14c associated with the URL to the user terminal 2. The user terminal 2 may display an item image on the search result page on the basis of the item image data 14c. Further, the information transmission unit 1103 may include, in the page information, information of the item that is to be displayed on the search result page.

As described above, the pieces of information of the plurality of respective items that have been found by the search unit 1101 may be displayed across two or more search result pages in a divided way. For example, the pieces of information of the respective items may be divided in units of items according to the maximum number of displayable items. In response to a search request from the user terminal 2, the information transmission unit 1103 may transmit page information of a first search result page among the two or more search result pages. The first search result page is a first page of the search result pages. Further, the information transmission unit 1103 may transmit the page information of the first search result page, and then transmit page information of a second search result page different from the first search result page among the two or more search result pages in response to a further request from the user terminal 2. The further request from the user terminal 2 may be a request transmitted by the user terminal 2 in response to a user operation on the first search result page. The second search result page in this case may be a second page of the search result pages. In a case where the search result pages are configured to allow the user to directly designate a page number of the search result page that the user wants to display, the second search result page is a search result page to which the designated page number is assigned.

In a case where the ratio that is acquired by the ratio acquisition unit 1102 as the ratio of the items in the predetermined category is lower than a predetermined threshold ratio, the information transmission unit 1103 may transmit page information for displaying two or more pieces of information on two or more respective items in a normal display mode. Further, in a case where the ratio that is acquired by the ratio acquisition unit 1102 is equal to or higher than predetermined the threshold ratio, the information transmission unit 1103 may transmit page information for displaying the two or more pieces of information on the two or more found items in a mode for the predetermined category. The display mode of the two or more pieces of information on the two or more respective items may include what the appearances of the information look like. For example, the search result page may include an item information display area of each item. The information of the item may be displayed in the item information display area. In the item information display area, the item image is displayed as at least a part of the information of the item. The display mode may include an occupancy rate of the item image with respect to the item information display area. This occupancy rate can be calculated by dividing an area of the item image in the search result page by an area of the item information display area. The display mode of the information on the item may be defined by at least one of the HTML document or the style sheet of the search result page. The occupancy rate of the item image does not need to be directly defined in the HTML document or the style sheet. For example, vertical and horizontal sizes of the item image and vertical and horizontal sizes of the item information display area may be defined in the HTML document or the style sheet. For example, for at least each of the normal display mode and the display mode for the predetermined category, the storage unit 14 of the shopping server 1 may store a template of the HTML document and the style sheet of the search result page. The information transmission unit 1103 may generate an HTML document of the search result page by using a template corresponding to a display mode. The display mode of the two or more pieces of information on the two or more respective items may or may not include the display format of the pieces of information of the plurality of items. Examples of the display format include a list format and a grid format. As will be described later, there may be a normal grid format and a fashion grid format as types of the grid format.

The information transmission unit 1103 may ensure that the occupancy rate of the item image in the display mode for the predetermined category is higher than the occupancy rate of the item image in the normal display mode. That is, the information transmission unit 1103 may ensure that the occupancy rate of the item image in a case where the ratio of the items in the predetermined category is equal to or higher than the threshold ratio is higher than the occupancy rate of the item image in a case where the ratio of the items in the predetermined category is lower than the threshold ratio. By increasing the occupancy rate of the item image, for the item of which the appearance has a relatively large influence on determination of selection of the item, the user can easily determine on which item to choose. In a case where the occupancy rate of the item image is higher, an area of the item image may be increased or may not be increased. In a case where an area of the item image is increased, the appearance of each item is more easily recognized. Even in a case where an area of the item image is not increased, more item images are displayed at a time on the screen of the user terminal 2. Therefore, the appearances of the items can be more easily compared. The threshold ratio may be preset. Examples of the threshold ratio include 30%, 508, 758, 90%, and 100%. In a case where it is desired to apply the display mode for the predetermined category when the number of the items in the predetermined category is relatively large among the items that have been found, for example, the threshold ratio may be determined within a range of 50% or higher.

The area of the item image in the display mode for the predetermined category may be larger or smaller than the area of the item image in the normal display mode. Alternatively, the areas of the item images may be the same as each other. As described above, the occupancy rate of the item image in the display mode for the predetermined category may be higher than the occupancy rate of the item image in the normal display mode. The information transmission unit 1103 may ensure that the number of parts of the information that are to be displayed in the item information display area in the display mode for the predetermined category is smaller than the number of parts of the information that are to be displayed in the item information display area in the normal display mode. Thereby, the occupancy rate of the item image may be increased. A size of each part of the information of the item other than the item image may be the same or different between the normal display mode and the display mode for the predetermined category.

The information transmission unit 1103 may ensure that a display format in the normal display mode is a list format. In addition, the information transmission unit 1103 may ensure that a display format in the display mode for the predetermined category is a grid format. The occupancy rate of the item image is more likely to be increased in the grid format than in the list format. Alternatively, the information transmission unit 1103 may ensure that the display format in the normal display mode and the display format for the predetermined category are the same. The information transmission unit 1103 may ensure that the occupancy rate of the item image in the display mode for the predetermined category is higher than the occupancy rate of the item image in the normal display mode in a state where the display formats are the same. The display format in this case may be either the list format or the grid format. In addition, the display format may be a format different from both the list format and the grid format.

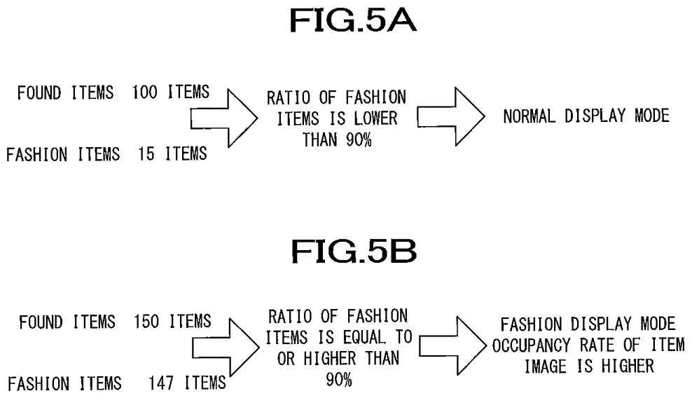

FIGS. 5A and 5B are diagrams illustrating an example of determining a display mode of information on an item. In the examples illustrated in FIGS. 5A and 5B and subsequent drawings, it is assumed that the predetermined category is fashion. In addition, it is assumed that the threshold ratio is 90%. As illustrated in FIG. 5A, 100 items are found as the items that satisfy the search condition. Among these items, the number of fashion items is 15. Therefore, the ratio of fashion items is 15%. Since the ratio is lower than the threshold ratio, the information transmission unit 1103 may select the normal display mode. On the other hand, as illustrated in FIG. 5B, 150 items are found as the items that satisfy the search condition. Among these items, the number of fashion items is 147. Therefore, the ratio of fashion items is 98%. Since the ratio is equal to or higher than the threshold ratio, the information transmission unit 1103 may select the FASHION DISPLAY MODE.

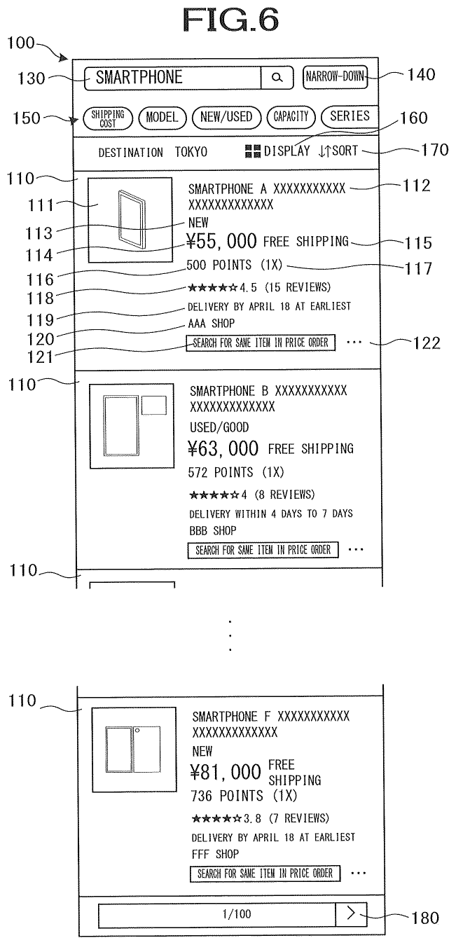

FIG. 6 is a diagram illustrating an example of a search result page in a case where the ratio of fashion items among the items that have been found is lower than the threshold ratio. The example of the search result page illustrated in FIG. 6 is an example of a case where the search result is displayed in a list format. Further, the example of the search result page illustrated in FIG. 6 illustrates an example of a case where a keyword “smartphone” is designated as the search condition. The items that have been found with the search condition may include smartphones and items that are related to smartphones. These items do not belong to fashion. As illustrated in FIG. 6, the search result page 100 may include a plurality of item information display areas 110. The item information display areas 110 are arranged in a list format. Each item information display area 110 may include, for example, an item image 111, an item name 112, an item state 113, a price 114, a shipping cost 115, a point score 116, a point multiplier 117, an evaluation 118, a shipping schedule 119, a store name 120, a related item search button 121, and a menu icon 122. Here, the point score 116 indicates how many points is to be given to a user who purchases the item corresponding to the item information display area 110. The evaluation 118 indicates an evaluation value that is given to the item by the purchasers and the number of registered evaluations. The shipping schedule indicates when the item will be shipped in a case where the item is purchased. The related item search button 121 is a button for searching for an item that is related to the item. For example, an item that is the same as the item and is less expensive may be found. In addition, for example, an item that has an appearance similar to the appearance of the item may be found by image search. The menu icon 122 is a button for displaying a menu for performing an operation related to the item. The search result page 100 may further include a keyword input field 130, a narrowing-down button 140, an attribute icon group 150, a display format change icon 160, a sorting icon 170, and a next page button 180. In the keyword input field 130, a keyword that has been input by the user on a web page displayed immediately before the search result page 100 may be displayed. The user can change the keyword in the keyword input field 130. The narrowing-down button 140 may be a button that is operable to add a further condition to the current search condition. The attribute icon group 150 includes a plurality of icons indicating names representing attributes of items. Each icon of the attribute icon group 150 is an element that is operable to search for items having the attribute indicated by the icon. The user can change the search condition to search for items by operating the keyword field 130, the narrowing-down button 140, or the attribute icon group 150. The display format change icon 160 is an element that is operable to change the display format of the search result to the grid format. The sorting icon 170 is an element that is operable to change a condition for determining the display rank of the items that have been found. The next page button 180 is an element that is operable to display a search result page with an assigned page number which is larger by one than the page number assigned to the currently-displayed search result page. In a case where the page number that is currently assigned to the search result page is equal to or larger than two, a previous page button (not illustrated) may be displayed on the search result page in addition to the next page button 180. The previous page button is an element that is operable to display a search result page with an assigned page number, which is smaller by one than the page number assigned to the currently-displayed search result page. Further, one or a plurality of page number links may be displayed on the search result page. The page number link is an element that is operable by the user to directly designate the page number and to display the search result page to which the designated page number is assigned.

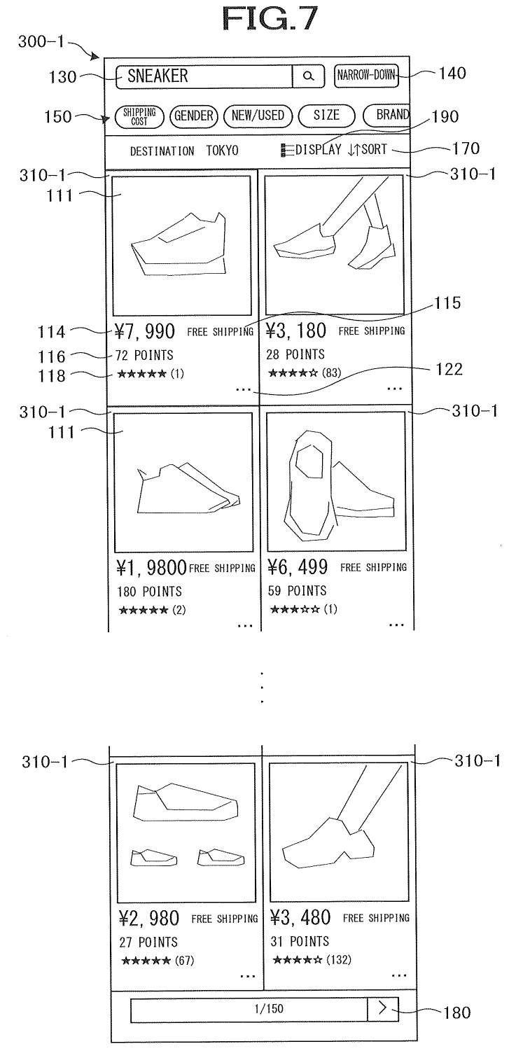

FIG. 7 is a diagram illustrating a first example of a search result page in a case where a ratio of fashion items among the items that have been found is equal to or higher than a threshold ratio. In FIG. 7, elements that are the same as the elements in FIG. 6 are denoted by the same reference numerals. The example of the search result page illustrated in FIG. 7 is an example of a case where the search result is displayed in a grid format. Further, the example of the search result page illustrated in FIG. 7 illustrates an example of a case where a keyword “sneaker” is designated as the search condition. The items that have been found by the search condition may include sneakers and items that are related to sneakers. Among these items, at least sneakers belong to fashion. As illustrated in FIG. 7, the search result page 300-1 may include a plurality of item information display areas 310-1. The item information display areas 310-1 are arranged in two columns and a plurality of rows. Each of the item information display areas 310-1 may include, for example, an item image 111, a price 114, a shipping cost 115, a point score 116, an evaluation 118, and a menu icon 122. As compared with the item information display area 110 illustrated in FIG. 6, the item name 112, the item state 113, the point multiplier 117, the shipping schedule 119, the store name 120, and the related item search button 121 are not displayed. The search result page 300-1 may further include a keyword input field 130, a narrowing-down button 140, an attribute icon group 150, a display format change icon 190, a sorting icon 170, and a next page button 180. The display format change icon 190 is an element that is operable to change the display format of the search result to the list format.

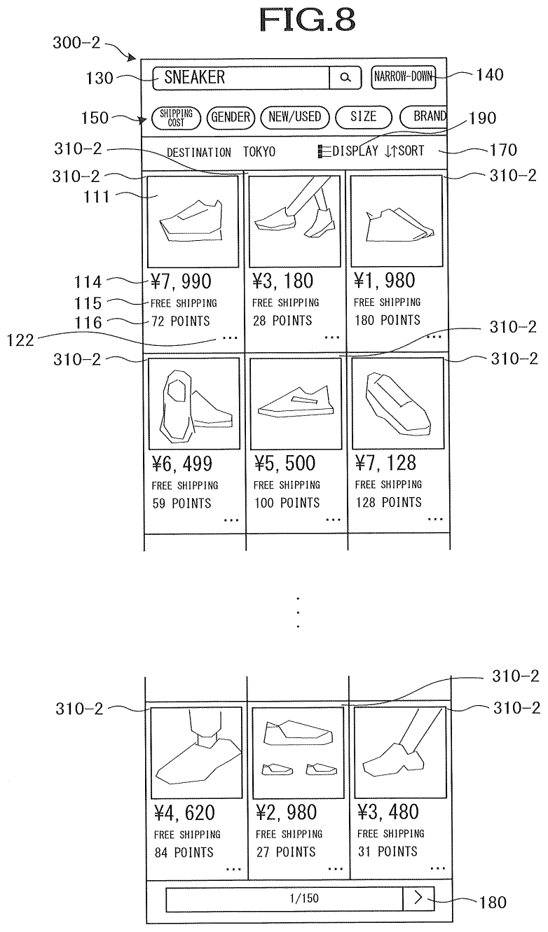

FIG. 8 is a diagram illustrating a second example of a search result page in a case where a ratio of fashion items among the items that have been found is equal to or higher than a threshold ratio. In FIG. 8, elements that are the same as the elements in FIG. 7 are denoted by the same reference numerals. As illustrated in FIG. 8, the search result page 300-2 may include a plurality of item information display areas 310-2. The item information display areas 310-2 are arranged in three columns and a plurality of rows. Each of the item information display areas 310-2 may include, for example, an item image 111, a price 114, a shipping cost 115, a point score 116, and a menu icon 122. As compared with the item information display area 310-1 illustrated in FIG. 7, the evaluation 118 is not displayed. The search result page 300-2 may further include a keyword input field 130, a narrowing-down button 140, an attribute icon group 150, a display format change icon 190, a sorting icon 170, and a next page button 180.

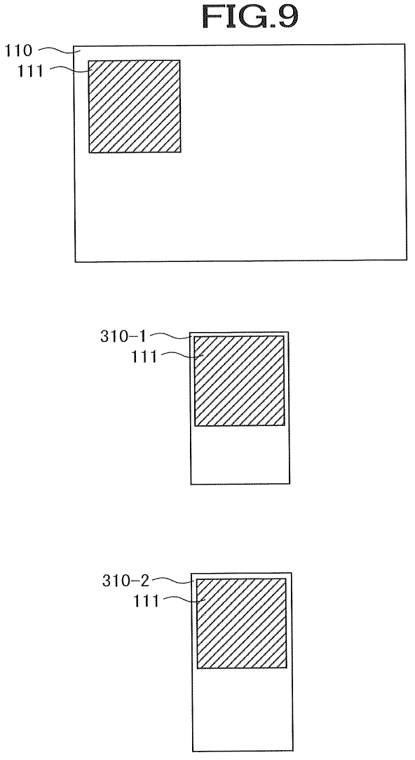

FIG. 9 is a diagram illustrating a comparative example of the occupancy rates of the item images. As illustrated in FIG. 9, item information display areas 110, 310-1, and 310-2 are illustrated. In addition, an item image 111 included in each of the item information display areas is illustrated. A size of the item information display area is changed for convenience such that sizes of the item images 111 match with each other between the item information display areas. As illustrated in FIG. 9, both the occupancy rate of the item image 111 with respect to the item information display area 310-1 and the occupancy rate of the item image 111 with respect to the item information display area 310-2 are higher than the occupancy rate of the item image 111 with respect to the item information display area 100.

The setting reception unit 1104 may receive, from the user terminal 2, setting of the display format of the pieces of information on the items on the search result page. For example, the user may be able to set the display format by operating the display format change icon 160 or 190 included in the search result page. A format to which the display format can be set may include the list format and the grid format.

The setting reception unit 1104 may separately manage the setting of the display format in a case where the ratio of the items in the predetermined category is lower than the threshold ratio and the setting of the display format in a case where the ratio of the items in the predetermined category is equal to or higher than the threshold ratio. For example, the display format setting DB 14b stores, for each user, a normal display format and a fashion display format. The normal display format indicates a display format in the normal display mode. The fashion display format indicates a display format in the fashion display mode. For example, the setting reception unit 1104 may change the normal display format in response to an operation of the display format change icon included in the search result page displayed in a case where the ratio of the items in the predetermined category is lower than the threshold ratio. Further, the setting reception unit 1104 may change the fashion display format in response to an operation of the display format change icon included in the search result page displayed in a case where the ratio of the items in the predetermined category is equal to or higher than the threshold ratio.

Note that the setting reception unit 1104 may match the display format that is set by the user in a case where the ratio of the items in the predetermined category is lower than the threshold ratio with the display format that is set by the user in a case where the ratio of the items in the predetermined category is equal to or higher than the threshold ratio. Here, the default display format in a case where the ratio of the items in the predetermined category is lower than the threshold ratio is a list format. In addition, the default display format in a case where the ratio of the items in the predetermined category is equal to or higher than the threshold ratio is a grid format. Therefore, each display format may be separately managed for convenience. The setting reception unit 1104 may change both the normal display format and the fashion display format to the same display format in response to an operation of the display format change icon.

In a case where the search request is transmitted from the user terminal 2 after the setting of the display format to the list format is received by the setting reception unit 1104, the information transmission unit 1103 may transmit page information for displaying the two or more pieces of information on the two or more respective items in the normal display mode even in a case where the ratio of the items in the predetermined category included in the plurality of items that have been found by the search unit 1101 in response to the search request is equal to or higher than the threshold ratio. Here, the information transmission unit 1103 may cause the two or more pieces of information on the two or more items in the normal display mode in a case where the display format is set to the list format in a situation where the ratio of the items in the predetermined category is equal to or higher than the threshold ratio. For example, as described above, it is assumed that the setting of the display format is indicated by the fashion display format. In this case, the information transmission unit 1103 can generate an HTML document of the search result page according to the display format indicated by the fashion display format.

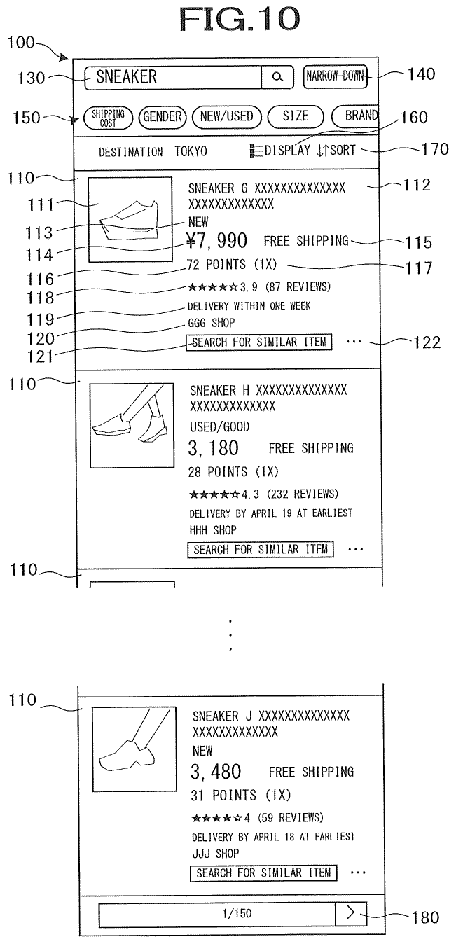

FIG. 10 is a diagram illustrating an example of a search result page in a case where a ratio of fashion items among the items that have been found is equal to or higher than the threshold ratio after the display format is changed to the list format. In FIG. 10, elements that are the same as the elements in FIG. 6 are denoted by the same reference numerals. Further, the example of the search result page illustrated in FIG. 10 illustrates an example of a case where a keyword “sneaker” is designated as the search condition. Note that the search result page illustrated in FIG. 10 is displayed even in a case where the user operates the display format change icon 190 included in the search result page illustrated in FIG. 7 or FIG. 8. As illustrated in FIG. 10, the elements included in the search result page 100, the display format, and the occupancy rate of the item image 111 are the same as those of the search result page 100 illustrated in FIG. 6.

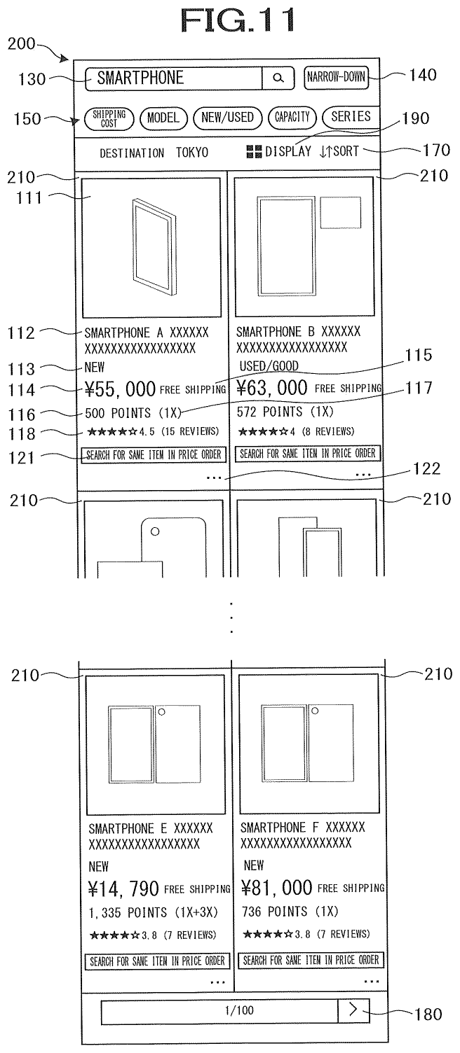

FIG. 11 is a diagram illustrating an example of a search result page in a case where a ratio of fashion items among the items that have been found is lower than the threshold ratio after the display format is changed to the grid format. In FIG. 11, elements that are the same as the elements in FIG. 6 are denoted by the same reference numerals. Further, the example of the search result page illustrated in FIG. 11 illustrates an example of a case where a keyword “smartphone” is designated as the search condition. As illustrated in FIG. 11, the search result page 200 may include a plurality of item information display areas 210. The item information display areas 210 are arranged in a grid format. The item information display areas 210 are arranged in two columns and a plurality of rows. Each of the item information display areas 210 may include, for example, an item image 111, an item name 112, an item state 113, a price 114, a shipping cost 115, a point score 116, a point multiplier 117, an evaluation 118, a related item search button 121, and a menu icon 122. As compared with the item information display area 110 illustrated in FIG. 6, the shipping schedule 119 and the store name 120 are not displayed. The search result page 200 may further include a keyword input field 130, a narrowing-down button 140, an attribute icon group 150, a display format change icon 190, a sorting icon 170, and a next page button 180. The display format change icon 190 is an element that is operable to change the display format of the search result to the list format.

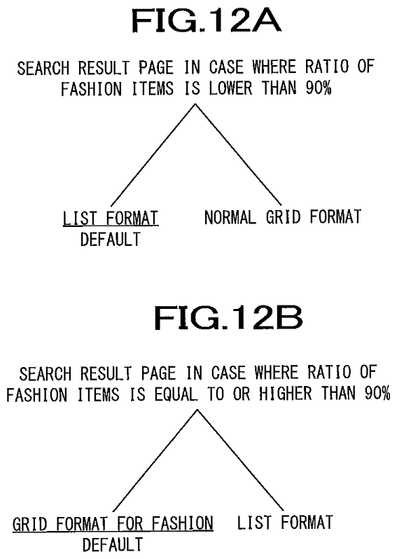

As an example, in a case where the predetermined category is fashion, there may be at least two types of display formats of the search result pages in a case where the ratio of the fashion items is lower than the threshold ratio and at least two types of display formats of the search result pages in a case where the ratio of the fashion items is equal to or higher than the threshold ratio. FIG. 12A is a diagram illustrating an example of a correspondence relationship between the search result page and the display format in a case where the ratio of the fashion items is lower than the threshold ratio. As illustrated in FIG. 12A, the default display format in a case where the ratio of the fashion items is lower than the threshold ratio is the list format. The user can change the display format to a grid format. The grid format at this time is referred to as a normal grid format. FIG. 12B is a diagram illustrating an example of a correspondence relationship between the search result page and the display format in a case where the ratio of the fashion items is equal to or higher than the threshold ratio. As illustrated in FIG. 12B, the default display format in a case where the ratio of the fashion items is equal to or higher than the threshold ratio is a grid format. This grid format is referred to as a fashion grid format. The user can change the display format to the list format. As described above, in a case where there are a plurality of types of display formats, the occupancy rate of the item image in the default display format in a case where the ratio of the fashion items is equal to or higher than the threshold ratio may be higher than the occupancy rate of the item image in the default display format in a case where the ratio of the fashion items is lower than the threshold ratio. That is, the occupancy rate of the item image in the grid format for fashion may be higher than the occupancy rate of the item image in the list format. The occupancy rate of the item image in the grid format for fashion may or may not be higher than the occupancy rate of the item image in the normal grid format. The occupancy rate of the item image 111 in each of the search result page 300-1 illustrated in FIG. 7 and the search result page 300-2 illustrated in FIG. 8 is higher than the occupancy rate of the item image 111 in the search result page 200 illustrated in FIG. 11. For example, each of the item information display areas 210 in the search result page 200 illustrated in FIG. 11 includes an item name 112, an item state 113, a point multiplier 117, and a related item search button 121. On the other hand, the search result page 300-1 illustrated in FIG. 7 does not include these parts of the information. As described above, the default display format in a case where the ratio of the fashion items is lower than the threshold ratio and the default display format in a case where the ratio of the fashion items is equal to or higher than the threshold ratio may be the same. Even in this case, the occupancy rate of the item image in the default display format in a case where the ratio of the fashion items is equal to or higher than the threshold ratio may be higher than the occupancy rate of the item image in the default display format in a case where the ratio of the fashion items is lower than the threshold ratio.

### 1-4. Operation of Shopping Server

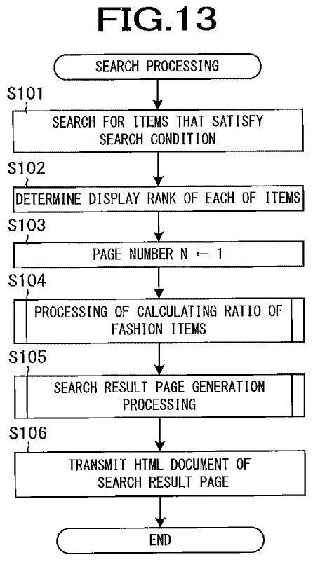

Next, an operation of the shopping server 1 will be described with reference to FIGS. 13 to 17. The system controller 11 may execute processing illustrated in FIGS. 13 to 17 according to various program codes included in the server program. The order of the processing is not limited to the order illustrated in FIGS. 13 to 17. Further, at least one of steps illustrated in FIGS. 13 to 17 may not be executed.

FIG. 13 is a flowchart illustrating an example of search processing executed by the system controller 11 of the shopping server 1 according to the present embodiment. For example, the system controller 11 may execute the search processing in response to the shopping server 1 receiving the search request from any of the user terminals 2.

As illustrated in FIG. 13, first, the search unit 1101 searches for items that satisfy the search condition included in the search request (step S101). Next, the search unit 1101 determines the display rank assigned to each of items that have been found. Next, the information transmission unit 1103 sets a page number N of the search result page to 1 (step S103). Next, the ratio acquisition unit 1102 executes processing of calculating a ratio of fashion items (step S104).

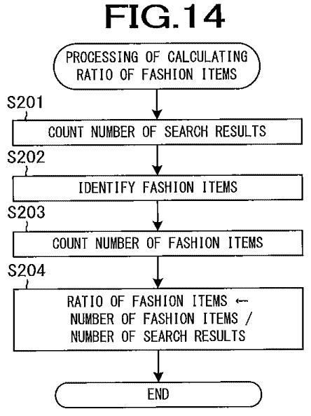

FIG. 14 is a flowchart illustrating an example of processing that is for calculating a ratio of fashion items and is executed by the system controller 11 of the shopping to the present embodiment. As server 1 according illustrated in FIG. 14, the ratio acquisition unit 1102 counts the number of the items that have been found by the search unit 1101 as the number of search results (step S201). Next, the ratio acquisition unit 1102 identifies items belonging to a fashion category, from among the items that have been found, on the basis of the category information that is in the DB in stored item 14a association with the item IDs of the items that have been found (step S202). Next, the ratio acquisition unit 1102 counts the number of the identified items (step S203). Next, the ratio acquisition unit 1102 calculates a ratio of fashion items by dividing the number of the items belonging to the fashion category by the number of search results (step S204). In a case where step S204 is ended, the processing of calculating the ratio of the fashion items is ended.

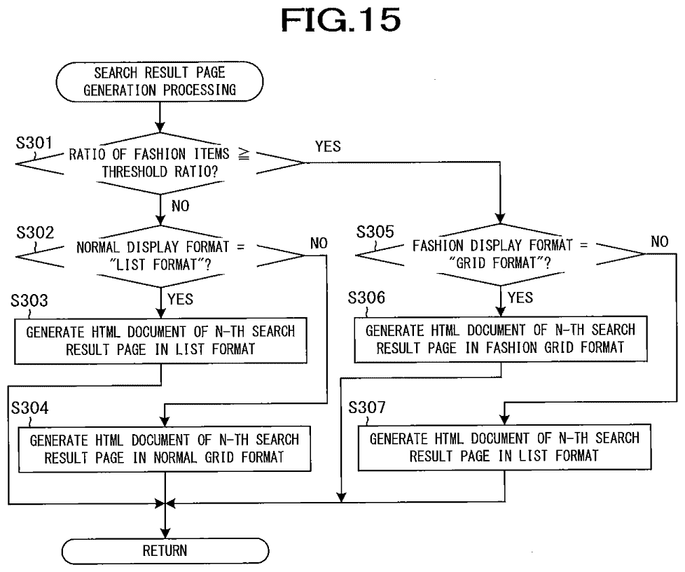

Returning to FIG. 13, in a case where the processing of calculating the ratio of the fashion items is ended, the information transmission unit 1103 executes search result page generation processing (step S105). FIG. 15 is a flowchart illustrating an example of search result page generation processing executed by the system controller 11 of the shopping server 1 according to the present embodiment. As illustrated in FIG. 15, first, the information transmission unit 1103 determines whether or not the ratio of the fashion items is equal to or higher than the threshold ratio (step S301). In a case where the ratio of the fashion items is lower than the threshold ratio (NO in step S301), the information transmission unit 1103 determines whether or not the normal display format that is stored in the display format setting DB 14b in association with the user ID included in the request transmitted from the user terminal 2 is “list format” (step S302). In a case where the normal display format is “list format” (YES in step S303), the information transmission unit 1103 generates an HTML document of the N-th search result page in the list format (step S303). In a case where the normal display format is “grid format” (NO in step S303), the information transmission unit 1103 generates an HTML document of the N-th search result page in the normal grid format (step S304).

In a case where the ratio of the fashion items is equal to or higher than the threshold ratio (YES in step S301), the information transmission unit 1103 determines whether or not the display format for fashion that is stored in the display format setting DB 14b in association with the user ID included in the request transmitted from the user terminal 2 is “grid format” (step S305). In a case where the fashion display format is “grid format” (YES in step S305), the information transmission unit 1103 generates an HTML document of the N-th search result page in the fashion grid format (step S306). In a case where the fashion display format is “list format” (NO in step S305), the information transmission unit 1103 generates an HTML document of the N-th search result page in the list format (step S307).

In steps S303, S304, S306, and S307, the information transmission unit 1103 may acquire, from the storage unit 14, a template and a style sheet of the HTML document of the search result page that correspond to the display format. The storage unit 14 may store a template and a style sheet of the HTML document that correspond to each of the list format, the normal grid format, and the grid format for fashion. The information transmission unit 1103 may generate the HTML document of the search result page on the basis of the acquired template. At this time, the information transmission unit 1103 may identify items on which pieces of information are to be displayed on the N-th search result page, on the basis of the page number N, the maximum number of displayable items, and the display rank of each of the items that have been found. The information transmission unit 1103 may acquire, for each of the identified items, part of the information to be displayed in the item display area according to the display format, from the item DB 14a and other databases. The information transmission unit 1103 may add the acquired information to the HTML document. Further, the information transmission unit 1103 may add the URL of the item image to the HTML document on the basis of the item image ID. In addition, the information transmission unit 1103 may generate the HTML document such that the request transmitted from the user terminal to the shopping server 1 in response to an operation of the display format change icon included in the search result page includes the page number N, information indicating whether the display format after the change is the list format or the grid format, and information indicating whether or not the ratio of the fashion items is equal to or higher than the threshold ratio. Further, the information transmission unit 1103 may generate the HTML document such that the search result page includes at least one of the next page button or the previous page button, on the basis of the number of search results and the page number N. At this time, the information transmission unit 1103 may generate the HTML document such that the request transmitted from the user terminal to the shopping server 1 in response to an operation of the next page button or the previous page button includes the page number of the search result page that corresponds to the button and information indicating whether or not the ratio of the fashion items is equal to or higher than the threshold ratio. In a case where step S303, S304, S306, or S307 is ended, the search result page generation processing is ended.

Returning to FIG. 13, in a case where the search result page generation processing is ended, the information transmission unit 1103 transmits the generated: HTML document of the search result page to the user terminal 2 that has transmitted the search request (step S106). In a case where step S106 is ended, the search processing is ended.

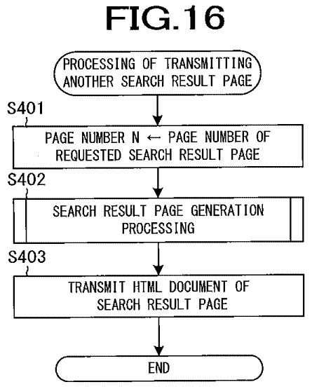

FIG. 16 is a flowchart illustrating an example of processing that is for transmitting another search result page and is executed by the system controller 11 of the shopping server 1 according to the present embodiment. For example, the user operates the next page button or the previous page button on the search result page displayed on the user terminal 2. In a case where the operation is detected, the user terminal 2 may transmit a request for another search result page to the shopping server 1. The request for another search result page may include, for example, the user ID of the user, the page number of the search result page that corresponds to the operated button, and information indicating whether or not the ratio of the fashion items is equal to or higher than the threshold ratio. The system controller 11 may execute processing of transmitting another search result page in a case where the request for another search result page is received from the user terminal 2.

As illustrated in FIG. 16, first, the information transmission unit 1103 sets the page number N to the page number included in the request for another search result page (step S401). Next, the information transmission unit 1103 executes search result page generation processing (step S402). In the search result page generation processing, an HTML document of the search result page may be generated on the basis of information that is included in the request for another search result page and indicates whether or not the ratio of fashion items is equal to or higher than the threshold ratio. That is, the HTML document of the search result page that is to be transmitted this time is generated in the same display mode as the display mode of the HTML document of the search result page that is currently displayed on the user terminal 2. Next, the information transmission unit 1103 transmits the generated HTML document to the user terminal 2 that has transmitted the request for another search result page (step S403). In a case where step S403 is ended, the processing of transmitting another search result page is ended.

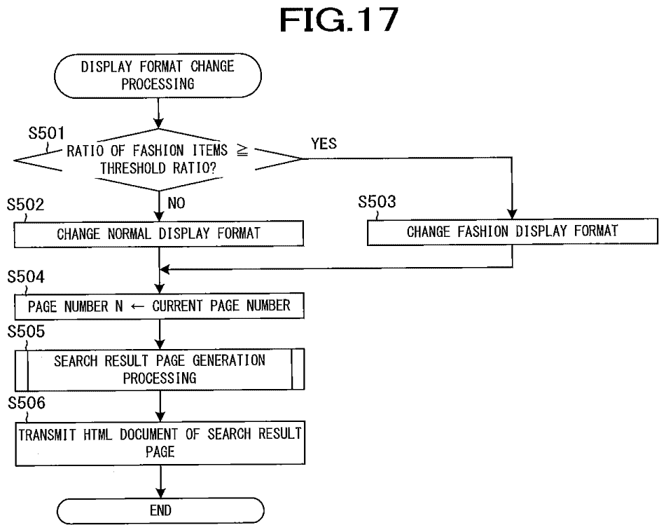

FIG. 17 is a flowchart illustrating an example of display format change processing executed by the system controller 11 of the shopping server 1 according to the present embodiment. For example, the user operates the display format change button on the search result page displayed on the user terminal 2. In a case where the operation is detected, the user terminal 2 may transmit a display format change request to the shopping server 1. The display format change request may include, for example, the user ID of the user, the page number of the currently-displayed search result page, information indicating whether the display format will be changed to the list format or the grid format, and information indicating whether or not the ratio of the fashion items is equal to or higher than the threshold ratio. The system controller 11 may execute display format change processing in response to receiving the display format change request from the user terminal 2.

As illustrated in FIG. 17, first, the setting reception unit 1104 determines whether or not the ratio of the fashion items is equal to or higher than the threshold ratio on the basis of information included in the display format change request (step S501). In a case where the ratio of the fashion items is lower than the threshold ratio (NO in step S501), the setting reception unit 1104 changes the normal display format that is stored in the display format setting DB 14b in association with the user ID included in the display format change request, to the display format included in the display format change request (step S502). In a case where the ratio of the fashion items is equal to or higher than the threshold ratio (YES in step S501), the setting reception unit 1104 changes the fashion display format that is stored in the display format setting DB 14b in association with the user ID included in the display format change request, to the display format included in the display format change request (step S503). After step S502 or after step S503, the information transmission unit 1103 sets the page number N to the current page number included in the display format change request (step S504). Next, the information transmission unit 1103 executes search result page generation processing (step S505). Next, the information transmission unit 1103 transmits the generated HTML document to the user terminal 2 that has transmitted the display format change request (step S506). In a case where step S506 is ended, the display format change processing is ended.

As described above, according to the present embodiment, the shopping server 1 may acquire the ratio of the items in the predetermined category included in the plurality of items that have been found in response to the search request from the user terminal 2. In addition, the shopping server 1 may transmit, to the user terminal 2, page information causing the user terminal 2 to display the search result page including two or more pieces of information on two or more respective items among the plurality of items that have been found. In addition, in a case where the ratio of the items in the predetermined category is lower than the threshold ratio, the shopping server 1 may transmit page information for displaying the pieces of information on the items in the normal display mode. In addition, in a case where the ratio of the items in the predetermined category is equal to or higher than the threshold ratio, the shopping server 1 may transmit page information for displaying the pieces of information on the items in the display mode for the predetermined category. In addition, the shopping server 1 may ensure that the occupancy rate of the item image in the display mode for the predetermined category is higher than the occupancy rate of the item image in the normal display mode. In this case, the occupancy rate of the item image with respect to the item information display area on the search result page, which is displayed in a case where the ratio of the items in the predetermined category is equal to or higher than the threshold ratio, is higher than the occupancy rate of the item image with respect to the item information display area on the search result page, which is displayed in a case where the ratio of the items in the predetermined category is lower than the threshold ratio. Therefore, the pieces of information on the respective items can be displayed in the mode corresponding to the items that have been found.

Here, the shopping server 1 may receive the setting of the display format from the user terminal 2. In addition, in a case where the search request is received after the setting indicating that the display format is set to the list format is received, the shopping server 1 may transmit page information for displaying the pieces of information on the items in the normal display mode even in a case where the ratio of the items in the predetermined category included in the plurality of items that have been found in response to the search request is equal to or higher than the threshold ratio. In this case, pieces of information on the items are displayed in the list format, and the occupancy rate of the item image with respect to the item information display area is lowered. Therefore, the display mode of the pieces of information on the items in a case where the ratio of the items in the predetermined category is equal to or higher than the threshold ratio can be set to a display mode according to the display format that is set by the user.

### 2. Second Embodiment

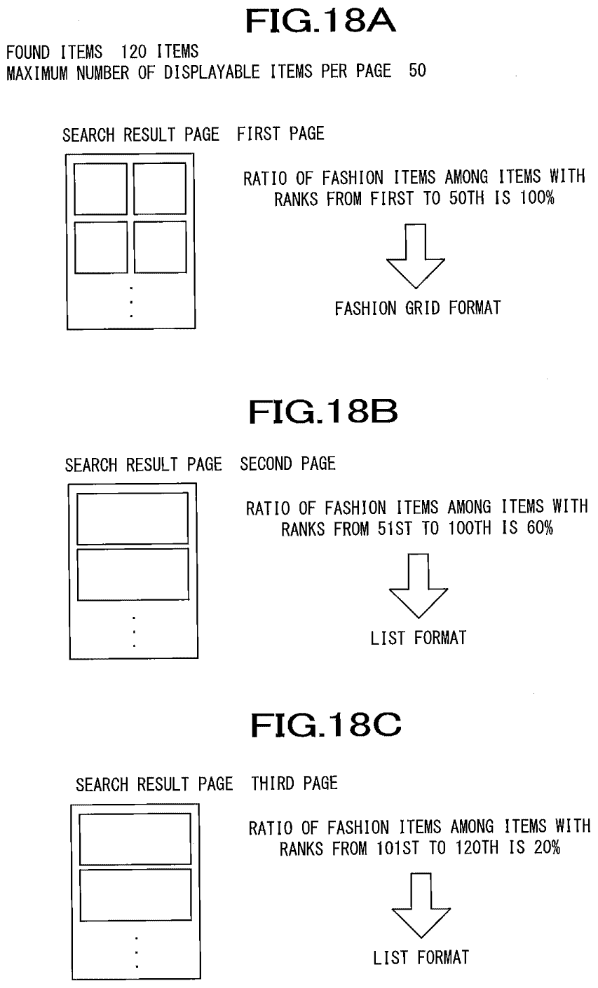

Next, a second embodiment will be described with reference to FIGS. 18A to 20. The present embodiment may be identical to the first embodiment except for points to be described below.

In the present embodiment, in a case where the number of the items that have been found by the search unit 1101 exceeds a predetermined number, the ratio acquisition unit 1102 may acquire the ratio of the items in the predetermined category among a predetermined number of items with higher display ranks among the found items. The predetermined number may be, for example, the maximum number of displayable items in the search result page.

Here, the ratio acquisition unit 1102 may acquire the ratio of the items in the predetermined category among items on which two or more respective pieces of information are displayed on the search result page corresponding to the page information transmitted by the information transmission unit 1103. For example, the ratio acquisition unit 1102 may acquire, in response to the search request from the user terminal 2, the ratio of the items in the predetermined category among two or more items on which the two or more respective pieces of information are displayed on the first search result page among the items that have been found by the search unit 1101. Further, for example, the ratio acquisition unit 1102 may acquire, in response to a further request from the user terminal 2 after the page information of the first search result page is transmitted, the ratio of the items in the predetermined category among two or more items on which two or more respective the pieces of information are displayed on the second search result page among the items that have been found by the search unit 1101. The further request from the user terminal 2 may be, for example, the request for another search result page. In the present embodiment, the items that satisfy the predetermined condition may be items on which the pieces of information are displayed on the search result page to be displayed.

In a case of transmitting the page information, the information transmission unit 1103 may transmit the page information for displaying the two or more pieces of information on the two or more respective items in the display mode corresponding to the ratio acquired by the ratio acquisition unit 1102 for the search result page corresponding to the page information. For example, in a case of transmitting the page information of the first search result page, the information transmission unit 1103 may transmit the page information for displaying two or more pieces of information on two or more respective items in the display mode corresponding to the ratio acquired for the first search result page. In addition, in a case of transmitting the page information of the second search result page, the information transmission unit 1103 may transmit the page information for displaying two or more pieces of information on two or more respective items in the display mode corresponding to the ratio acquired for the second search result page. Thereby, the display mode of the pieces of information on the items may be changed according to a change in the page number of the search result page to be displayed on the user terminal 2.

FIGS. 18A to 18C are diagrams illustrating an example of determining the display format. In the example illustrated in FIGS. 18A to 18C, it is assumed that the user has not changed the display format in the past. In addition, it is assumed that the threshold ratio is 90%. For example, the search unit 1101 finds out 120 items in response to a search request from the user terminal 2. In addition, it is assumed that the maximum number of displayable items per search result page is 50. As illustrated in FIG. 18A, first, the information transmission unit 1103 generates an HTML document of the first search result page. In the first search result page, the pieces of information on the respective items with display ranks from first to 50th are displayed. The ratio of fashion items among the items with display ranks from first to 50th is 100%. Therefore, the display format of the first search result page is the fashion grid format. As illustrated in FIG. 18B, in response to a further request from the user terminal 2 based on an operation on the next page button, the information transmission unit 1103 generates an HTML document of the second search result page. In the second search result page, the pieces of information on the respective items with display ranks from 51st to 100th are displayed. The ratio of fashion items among the items with display ranks from 51st to 100th is 60%. Therefore, the display format of the second search result page is the list format. As illustrated in FIG. 18C, in response to a still further request from the user terminal 2 based on an operation on the next page button, the information transmission unit 1103 generates an HTML document of the third search result page. In the third search result page, the pieces of information on the respective items with display ranks from 101st to 120th are displayed. The ratio of fashion items among the items with display ranks from 101st to 120th is 20%. Therefore, the display format of the third search result page is the list format.

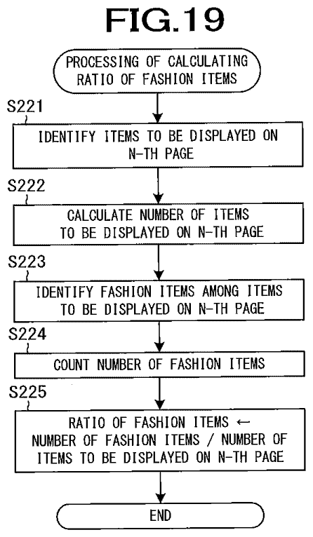

FIG. 19 is a flowchart illustrating an example of processing that is for calculating a ratio of fashion items and is executed by the system controller 11 of the shopping server 1 according to the present embodiment. As illustrated in FIG. 19, the ratio acquisition unit 1102 identifies the items on which the pieces of information are displayed on the N-th search result page, on the basis of the page number N, the maximum number of displayable items, and the display rank of each of the items that have been found (step S221). Next, the ratio acquisition unit 1102 calculates the number of the items on which the pieces of information are displayed on the N-th search result page, on the basis of the page number N and the maximum number of displayable items (step S222). Next, the ratio acquisition unit 1102 identifies the items belonging to the fashion category from among the items on which the pieces of information are displayed on the N-th search result page, on the basis of the category information (step S223). Next, the ratio acquisition unit 1102 counts the number of the items belonging to the fashion category (step S224). Next, the ratio acquisition unit 1102 calculates the ratio of the fashion items by dividing the number of the items belonging to the fashion category by the number of the items on which the pieces of information are displayed on the N-th search result page (step S225). In a case where step S225 is ended, the processing of calculating the ratio of the fashion items is ended.

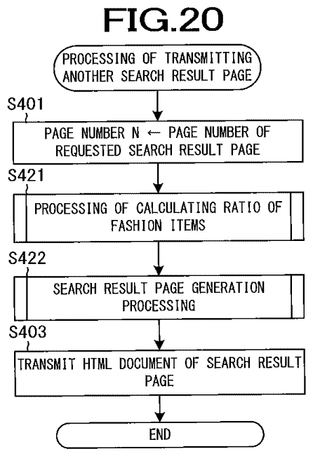

FIG. 20 is a flowchart illustrating an example of processing that is for transmitting another search result page and is executed by the system controller 11 of the shopping server 1 according to the present embodiment. In FIG. 20, steps that are the same as the steps in FIG. 16 are denoted by the same reference numerals. As illustrated in FIG. 20, first, the information transmission unit 1103 sets the page number N to the page number included in the request for another search result page (step S401). Next, the information transmission unit 1103 executes processing of calculating the ratio of the fashion items (step S421). Next, the information transmission unit 1103 executes search result page generation processing (step S422). In the search result page generation processing, an HTML document of the search result page may be generated on the basis of the ratio calculated in step S421. Next, the information transmission unit 1103 transmits the generated HTML document to the user terminal 2 that has transmitted the request for another search result page (step S403). In a case where step S403 is ended, the processing of transmitting another search result page is ended.

As described above, according to the present embodiment, it is possible to display the pieces of information on the respective items in the mode corresponding to the items on which the respective pieces of information are actually displayed on each of the search result pages.

### 3. Third Embodiment

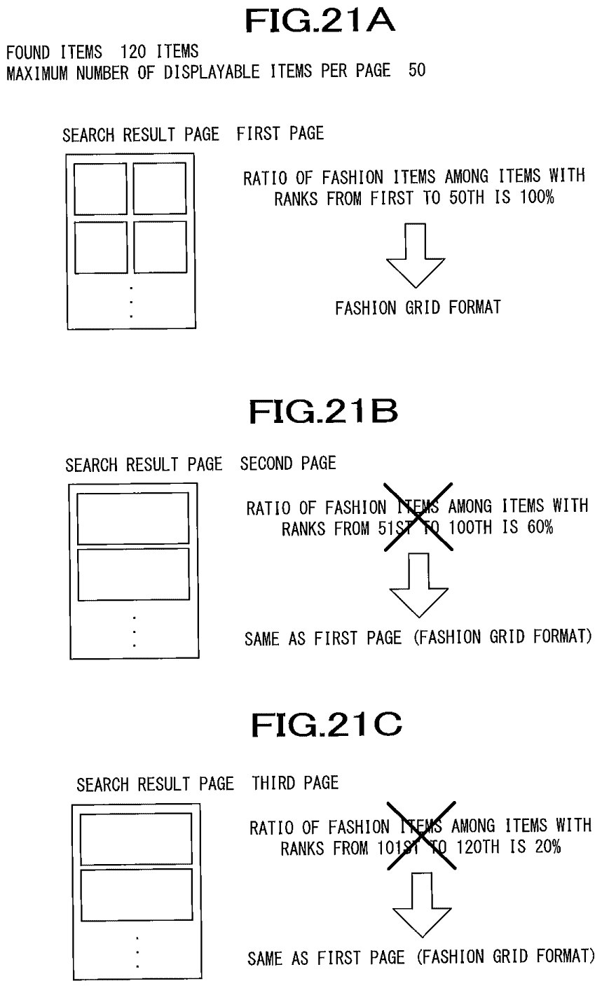

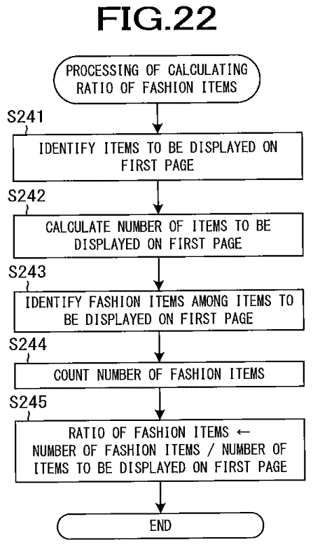

Next, a third embodiment will be described with reference to FIGS. 21A to 22. Except for points to be described below, the present embodiment may be identical to at least one of the embodiments described above.

Even in the present embodiment, in a case where the number of the items that have been found by the search unit 1101 exceeds the predetermined number, the ratio acquisition unit 1102 may acquire the ratio of the items in the predetermined category among the predetermined number of items of which the display rank is higher among the found items.

In the present embodiment, the ratio acquisition unit 1102 may acquire the ratio of the items in the predetermined category among the two or more items on which the two or more respective pieces of information are displayed on the first search result page among the items that have been found by the search unit 1101. Here, the ratio acquisition unit 1102 may acquire the ratio of the items in the predetermined category among the two or more items on which the two or more respective pieces of information are displayed on the first search result page in response to the search request. In the present embodiment, the items that satisfy the predetermined condition may be items on which the pieces of information are displayed on the first search result page.

The information transmission unit 1103 may transmit, as the ratio of the items in the predetermined category, the page information for displaying the two or more pieces of information on the two or more respective items in the display mode corresponding to the ratio acquired by the ratio acquisition unit 1102 for the first search result page. Here, regardless of whether the search result page corresponding to the page information to be transmitted is the first search result page or the second search result page, the information transmission unit 1103 may cause the pieces of information of the items to be displayed in the display mode corresponding to the ratio acquired for the first search result page. Thereby, the display mode of all search result pages is determined by the items on which the pieces of information are displayed on the first search result page.

FIGS. 21A to 21C are diagrams illustrating an example of determining the display format. Similarly to FIGS. 18A to 18C, it is assumed that the user has not changed the display format in the past. In addition, it is assumed that the threshold ratio is 90%. In addition, it is assumed that the number of search results is 120. In addition, it is assumed that the maximum number of displayable items per search result page is 50. As illustrated in FIG. 21A, first, the information transmission unit 1103 generates an HTML document of the first search result page. In the first search result page, the pieces of information on the items with display ranks from first to 50th are displayed. The ratio of fashion items among the items with display ranks from first to 50th is 100%. Therefore, the display format of the first search result page is the fashion grid format. As illustrated in FIG. 21B, in response to a further request from the user terminal 2, information the transmission unit 1103 generates an HTML document of the second search result page. In the second search result page, the pieces of information on the items with display ranks from 51st to 100th are displayed. The ratio of fashion items among the items with display ranks from 51st to 100th is 60%. However, as the same as the first search result page, the display format of the second search result page is the fashion grid format. As illustrated in FIG. 21C, in response to a still further request from the user terminal 2, the information transmission unit 1103 generates an HTML document of the third search result page. In the third search result page, the pieces of information of the items with display ranks from 101st to 120th are displayed. The ratio of fashion items among the items with display ranks from 101st to 120th is 20%. In this case, as the same as the first search result page, the display format of the third search result page is the grid format for fashion.

In a case where the items are found in response to the search request, the first search result page is always displayed. On the other hand, the second and subsequent search result pages are not necessarily displayed. These search result pages are displayed only in a case where a further request is transmitted from the user terminal 2. Therefore, the display modes of all the search result pages from the first page to the last page are unified in the display mode according to the items on which the pieces of information are displayed on the first search result page that is always displayed. Therefore, it is possible to provide a sense of uniformity in the display modes among the plurality of search result pages while focusing on the items which the user is more likely to view.

FIG. 22 is a flowchart illustrating an example of processing that is for calculating a ratio of fashion items and is executed by the system controller 11 of the shopping server 1 according to the present embodiment. As illustrated in FIG. 22, the ratio acquisition unit 1102 identifies the items on which the pieces of information are displayed on the first search result page, on the basis of the maximum number of displayable items and the display rank of each of the items that have been found (step S241). Next, the ratio acquisition unit 1102 calculates the number of items on which the pieces of information are displayed on the first search result page, on the basis of the number of search results and the maximum number of displayable items (step S242). Next, the ratio acquisition unit 1102 identifies items belonging to the fashion category from among the items on which the pieces of information are displayed on the first search result page, on the basis of the category information (step S243). Next, the ratio acquisition unit 1102 counts the number of items belonging to the fashion category (step S244). Next, the ratio acquisition unit 1102 calculates a ratio of fashion items by dividing the number of items belonging to the fashion category by the number of items on which the pieces of information are displayed on the first search result page (step S245). In a case where step S245 is ended, the processing of calculating the ratio of the fashion item is ended.

The system controller 11 may execute the same processing as the processing that is for transmitting another search result page and is illustrated in FIG. 16. Thereby, regardless of the page number of the search result page to be displayed, the display mode of the search result page may be a display mode corresponding to the ratio calculated in the processing of calculating the ratio of the fashion items in the first search result page.

As described above, according to the present embodiment, it is possible to provide a sense of unity in the display mode of the pieces of information of the items among the plurality of search result pages by matching display modes to the display mode corresponding to the items on which the pieces of information are displayed on the search result page that is always displayed.

### 4. Fourth Embodiment

Next, a fourth embodiment will be described. Except for points to be described below, the present embodiment may be identical to at least one of the embodiments described above.

Even in the present embodiment, in a case where the number of the items that have been found by the search unit 1101 exceeds the predetermined number, the ratio acquisition unit 1102 may acquire the ratio of the items in the predetermined category among the predetermined number of items on which the display rank is higher among the plurality of found items. The present embodiment is different from the second embodiment and the third embodiment in that pieces of information of all items that have been found by the search unit 1101 are displayed on one search result page regardless of the number of search results. Therefore, the second and subsequent search result pages may not exist. The predetermined number may be predetermined by, for example, an operator of a reservation service. For example, it is assumed that the predetermined number has been set to 100. In a case where the number of search results is equal to or smaller than 100, the ratio acquisition unit 1102 may acquire the ratio of the items in the predetermined category among all the items that have been found. In a case where the number of search results exceeds 100, the ratio acquisition unit 1102 may acquire the ratio of the items in the predetermined category among the items with display ranks from first to 100th among the items that have been found. In the present embodiment, the items that satisfy the predetermined condition may be the predetermined number of items with a higher display rank.

The information transmission unit 1103 may transmit the page information for displaying the search result page including pieces of information of all the items that have been found.

In a case where the search result page includes pieces of information of items that cannot be displayed on the screen of the user terminal 2, the user scrolls the search result page or the screen to display the pieces of information of the items. Therefore, as the item has a higher display rank, the information of the item is more likely to be viewed by the user. Therefore, it is possible to display the pieces of information of the items in the mode corresponding to the items on which the pieces of information are more likely to be browsed.

(1) An item information provision device comprising: at least one memory configured to store program code; and at least one processor configured to access the program code and operate as instructed by the program code, the program code comprising: an acquisition code configured to cause the at least one processor to acquire a ratio of items in a predetermined category included in a plurality of items that have been found in response to a search request from a terminal device; and a transmission code configured to cause the at least one processor to transmit page information to the terminal device, the page information being for causing the terminal device to display a page including two or more pieces of information on two or more respective items among the plurality of found items, each of the two or more pieces of information on the two or more respective items including an image, wherein the transmission code is configured to cause the at least one processor to transmit the page information for displaying the two or more pieces of information on the two or more respective items in a predetermined first display mode in a case where the acquired ratio is lower than a predetermined ratio and transmit the page information for displaying the two or more pieces of information on the two or more respective items in a predetermined second display mode in a case where the acquired ratio is equal to or higher than the predetermined ratio, each of the two or more pieces of information on the two or more respective items is displayed in a respective display area in the page, each of the first display mode and the second display mode of the two or more pieces of information on the two or more respective items includes an occupancy rate of the image to the display area, and the occupancy rate in the second display mode is higher than the occupancy rate in the first display mode.

(2) The item information provision device according to (1), wherein pieces of information on the plurality of respective found items are included across two or more pages in units of a predetermined number of items, the transmission code is configured to cause the at least one processor to transmit the page information of a first page among the two or more pages in response to the search request, and transmit the page information of a second page different from the first page among the two or more pages in response to a further request from the terminal device after the page information of the first page is transmitted, the acquisition code is configured to cause the at least one processor to acquire, in response to the search request from the terminal device, the ratio of items in the predetermined category among two or more first items included in the plurality of found items and acquire, in response to the further request from the terminal device, the ratio of items in the predetermined category among two or more second items included in the plurality of found items, two or more pieces of information on the two or more respective first items are included in the first page, two or more pieces of information on the two or more respective second items are included in the second page, the transmission code is configured to cause the at least one processor to transmit, in a case of transmitting the page information of the first page, the page information for displaying the two or more pieces of information on the two or more respective first items in a display mode corresponding to the ratio acquired for the first page among the first display mode and the second display mode, and transmit, in a case of transmitting the page information of the second page, the page information for displaying the two or more pieces of information on the two or more respective second items in a display mode corresponding to the ratio acquired for the second page among the first display mode and the second display mode.

(3) The item information provision device according to (1), wherein pieces of information on the plurality of respective found items are included across two or more pages in units of a predetermined number of items, the transmission code is configured to cause the at least one processor to transmit the page information of a first page among the two or more pages in response to the search request, and transmit the page information of a second page different from the first page among the two or more pages in response to a further request from the terminal device after the page information of the first page is transmitted, the acquisition code is configured to cause the at least one processor configured to acquire the ratio of items in the predetermined category among two or more first items included in the plurality of found items, two or more pieces of information on the two or more respective first items are included in the first page, and the transmission code is configured to cause the at least one processor to transmit the page information for displaying the two or more pieces of information on the two or more respective items in a display mode corresponding to the ratio acquired for the first page among the first display mode and the second display mode, regardless of whether the page information of the first page or the page information of the second page is transmitted.

(4) The item information provision device according to any one of (1) to (3), wherein a rank is assigned to each of the plurality of found items, the transmission code is configured to cause the at least one processor to transmit the page information for displaying the page including the two or more pieces of information on the two or more respective items in order according to ranks assigned to the plurality of found items, and the acquisition code is configured to cause the at least one processor to acquire, in a case where the number of the plurality of found items exceeds a predetermined number, the ratio of the items in the predetermined category among the predetermined number of items that have higher ranks among the plurality of found items.

(5) The item information provision device according to any one of (1) to (4), wherein each of the first display mode and the second display mode includes a display format of the two or more pieces of information of the respective two or more items, the display format in the first display mode is a list format, the display format in the second display mode is a grid format, the program code further comprises a reception code configured to cause the at least one processor to receive setting of the display format from the terminal device, and the transmission code is configured to cause the at least one processor to transmit, in response to the search request after the setting of the display format to the list format is received by the reception code, the page information for displaying the two or more pieces of information on the two or more respective items in the first display mode even in a case where the ratio of the items in the predetermined category included in the plurality of items found in response to the search request is equal to or higher than the predetermined ratio.

(6) An item information provision method performed by at least one computer, the method comprising: acquiring a ratio of items in a predetermined category included in a plurality of items that have been found in response to a search request from a terminal device; and transmitting page information to the terminal device, the page information being for causing the terminal device to display a page including two or more pieces of information on two or more respective items among the plurality of found items, each of the two or more pieces of information on the two or more respective items including an image, wherein the page information for displaying the two or more pieces of information on the two or more respective items in a predetermined first display mode is transmitted in a case where the acquired ratio is lower than a predetermined ratio and the page information for displaying the two or more pieces of information on the two or more respective items in a predetermined second display mode is transmitted in a case where the acquired ratio is equal to or higher than the predetermined ratio, each of the two or more pieces of information on the two or more respective items is displayed in a respective display area in the page, each of the first display mode and the second display mode of the two or more pieces of information on the two or more respective items includes an occupancy rate of the image to the display area, and the occupancy rate in the second display mode is higher than the occupancy rate in the first display mode.

(7) A non-transitory computer readable medium having stored thereon an item information provision program configured to cause a computer to: acquire a ratio of items in a predetermined category included in a plurality of items that have been found in response to a search request from a terminal device; and transmit page information to the terminal device, the page information being for causing the terminal device to display a page including two or more pieces of information on two or more respective items among the plurality of found items, each of the two or more pieces of information on the two or more respective items including an image, wherein the page information for displaying the two or more pieces of information on the two or more respective items in a predetermined first display mode is transmitted in a case where the acquired ratio is lower than a predetermined ratio and the page information for displaying the two or more pieces of information on the two or more respective items in a predetermined second display mode is transmitted in a case where the acquired ratio is equal to or higher than the predetermined ratio, each of the first display mode and the second display mode of the two or more pieces of information on the two or more respective items includes an occupancy rate of the image to the display area, and each of the first display mode and the second display mode includes an occupancy rate of the image to the display area, and the occupancy rate in the second display mode is higher than the occupancy rate in the first display mode.

### REFERENCE SIGNS LIST

1 Shopping server
2 User terminal
11 System controller
12 System bus
13 Input/output interface
14 Storage unit
14a Item DB
14b Display format setting DB
14c Item image data
15 Communication unit
1101 Search unit
1102 Ration acquisition unit
1103 Information transmission unit
1104 Setting reception unit
NW Network

What is claimed is:

1. An item information provision device comprising:
at least one memory configured to store program code; and
at least one processor configured to access the program code and operate as instructed by the program code, the program code comprising:
an acquisition code configured to cause the at least one processor to acquire a ratio of items in predetermined category included in a plurality of items that have been found in response to a search request from a terminal device; and
a transmission code configured to cause the at least one processor to transmit page information to the terminal device, the page information being for causing the terminal device to display a page including two or more pieces of information on two or more respective items among the plurality of found items, each of the two or more pieces of information on the two or more respective items including an image,
wherein the transmission code is configured to cause the at least one processor to transmit the page information for displaying the two or more pieces of information on the two or more respective items in a predetermined first display mode in a case where the acquired ratio is lower than a predetermined ratio and transmit the page information for displaying the two or more pieces of information on the two or more respective items in a predetermined second display mode in a case where the acquired ratio is equal to or higher than the predetermined ratio,
each of the two or more pieces of information on the two or more respective items is displayed in a respective display area in the page,
each of the first display mode and the second display mode of the two or more pieces of information on the two or more respective items includes an occupancy rate of the image to the display area, and
the occupancy rate in the second display mode is higher than the occupancy rate in the first display mode.

2. The item information provision device according to claim 1, wherein
pieces of information on the plurality of respective found items are included across two or more pages in units of a predetermined number of items,
the transmission code is configured to cause the at least one processor to transmit the page information of a first page among the two or more pages in response to the search request, and transmit the page information of a second page different from the first page among the two or more pages in response to a further request from the terminal device after the page information of the first page is transmitted,
the acquisition code is configured to cause the at least one processor to acquire, in response to the search request from the terminal device, the ratio of items in the predetermined category among two or first more items included in the plurality of found items and acquire, in response to the further request from the terminal device, the ratio of items in the predetermined category among two or more second items included in the plurality of found items,
two or more pieces of information on the two or more respective first items are included in the first page,
two or more pieces of information on the two or more respective second items are included in the second page,
the transmission code is configured to cause the at least one processor to transmit, in a case of transmitting the page information of the first page, the page information for displaying the two or more pieces of information on the two or more respective first items in a display mode corresponding to the ratio acquired for the first page among the first display mode and the second display mode, and transmit, in a case of transmitting the page information of the second page, the page information for displaying the two or more pieces of information on the two or more respective second items in a display mode corresponding to the ratio acquired for the second page among the first display mode and the second display mode.

3. The item information provision device according to claim 1, wherein
pieces of information on the plurality of respective found items are included across two or more pages in units of a predetermined number of items,
the transmission code is configured to cause the at least one processor to transmit the page information of a first page among the two or more pages in response to the search request, and transmit the page information of a second page different from the first page among the two or more pages in response to a: further request from the terminal device after the page information of the first page is transmitted,
the acquisition code is configured to cause the at least one processor configured to acquire the ratio of items in the predetermined category among two or more first items included in the plurality of found items,
two or more pieces of information on the two or more respective first items are included in the first page, and
the transmission code is configured to cause the at least one processor to transmit the page information for displaying the two or more pieces of information on the two or more respective items in a display mode corresponding to the ratio acquired for the first page among the first display mode and the second display mode, regardless of whether the page information of the first page or the page information of the second page is transmitted.

4. The item information provision device according to claim 1, wherein
a rank is assigned to each of the plurality of found items,
the transmission code is configured to cause the at least one processor to transmit the page information for displaying the page including the two or more pieces of information on the two or more respective items in order according to ranks assigned to the plurality of found items, and
the acquisition code is configured to cause the at least one processor to acquire, in a case where the number of the plurality of found items exceeds a predetermined number, the ratio of the items in the predetermined category among the predetermined number of items that have higher ranks among the plurality of found items.

5. The item information provision device according to claim 1, wherein
each of the first display mode and the second display mode includes a display format of the two or more pieces of information of the respective two or more items,
the display format in the first display mode is a list format,
the display format in the second display mode is a grid format,
the program code further comprises a reception code configured to cause the at least one processor to receive setting of the display format from the terminal device, and
the transmission code is configured to cause the at least one processor to transmit, in response to the search request after the setting of the display format to the list format is received by the reception code, the page information for displaying the two or pieces of information on the two or more respective items in the first display mode even in a case where the ratio of the items in the predetermined category included in the plurality of items found in response to the search request is equal to or higher than the predetermined ratio.

6. An item information provision method performed by at least one computer, the method comprising:
acquiring a ratio of items in a predetermined category included in a plurality of items that have been found in response to a search request from a terminal device; and
transmitting page information to the terminal device, the page information being for causing the terminal device to display a page including two or more pieces of information on two or more respective items among the plurality of found items, each of the two or more pieces of information on the two or more respective items including an image,
wherein the page information for displaying the two or more pieces of information on the two or more respective items in a predetermined first display mode is transmitted in a case where the acquired ratio is lower than a predetermined ratio and the page information for displaying the two or more pieces of information on the two or more respective items in a predetermined second display mode is transmitted in a case where the acquired ratio is equal to or higher than the predetermined ratio,
each of the two or more pieces of information on the two or more respective items is displayed in a respective display area in the page,
each of the first display mode and the second display mode of the two or more pieces of information on the two or more respective items includes an occupancy rate of the image to the display area, and
the occupancy rate in the second display mode is higher than the occupancy rate in the first display mode.

7. A non-transitory computer readable medium having stored thereon an item information provision program configured to cause a computer to:
acquire a ratio of items in a predetermined category included in a plurality of items that have been found in response to a search request from a terminal device; and
transmit page information to the terminal device, the page information being for causing the terminal device to display a page including two or more pieces of information on two or more respective items among the plurality of found items, each of the two or more pieces of information on the two or more respective items including an image,
wherein the page information for displaying the two or more pieces of information on the two or more respective items in a predetermined first display mode is transmitted in a case where the acquired ratio is lower than a predetermined ratio and the page information for displaying the two or more pieces of information on the two or more respective items in a predetermined second display mode is transmitted in a case where the acquired ratio is equal to or higher than the predetermined ratio,
each of the first display mode and the second display mode of the two or more pieces of information on the two or more respective items includes an occupancy rate of the image to the display area, and
each of the first display mode and the second display mode includes an occupancy rate of the image to the display area, and
the occupancy rate in the second display mode is higher than the occupancy rate in the first display mode.
